(19) United States
(12) Patent Application Publication
(10) Pub. No.: US 2003/0172287 A1
(43) Pub. Date: Sep. 11, 2003

(54) Methods and apparatus for providing security for a resource

(76) Inventors: Paul J. Bailo, Trumball, CT (US); Ryan D. Keiffner, Stamford, CT (US); Woody Ladd, Rye, NY (US)

Correspondence Address: BUCKLEY, MASCHOFF, TALWALKAR, & ALLISON, 5 ELM STREET, NEW CANAAN, CT, 06840, US

(21) Appl. No.: 10/093,978

(22) Filed: Mar. 8, 2002

(51) Int. Cl. H04K 1/00

(52) U.S. Cl. 713/193

(57) ABSTRACT

Embodiments of the present invention provide a system, method, apparatus, means, and computer program code for distributing security information used to access a resource and for facilitating secure access to a resource. A method for facilitating security for access to a resource may include providing a first code to an individual at an address of record associated with the user, wherein the user is associated with an account; providing a second code to the first individual via a first statement for the account; and requiring the first individual to provide the first code and the second code when the first individual attempts to access a resource associated with the account.

### FIELD OF THE INVENTION

The present invention relates to a method and apparatus for providing security for a resource and, more particularly, embodiments of the present invention relate to methods, means, apparatus, and computer program code for providing multiple codes to individuals that may be used to access or use a resource.

### BACKGROUND OF THE INVENTION

Companies often provide resources for use or access by their customers. For example, a company may implement a World Wide Web (“Web”) site to provide information regarding the company's products, locations, contact information, etc. In some situations, a company allow a customer to access information relevant to the customer but not allow the customer view any information regarding any of the company's other customers, and vice versa. For example, a bank may allow access to a Web site that enables customers to view their account balances, withdrawals and deposits, checking account or debit card history, etc.

In order to provide secured access to a resource (e.g., Web site, database) by a customer, a company may require that the customer use a password to access or log into the resource. Unfortunately, providing such a password to the customer may itself be difficult, if not impossible, to conduct in a secure manner. For example, simply mailing the password the customer may provide an opportunity for the password to be stolen.

It would be advantageous to provide a method and apparatus that overcame the drawbacks of the prior art. In particular, it would be desirable to provide a method and apparatus that facilitated distribution of security information used to access a resource. In addition, it would be desirable to provide a method and apparatus for facilitating secure access to a resource.

### SUMMARY OF TILE INVENTION

Embodiments of the present invention provide a system, method, apparatus, means, and computer program code for distributing security information used to access a resource and for facilitating secure access to the resource. A resource may be used to provide information to users regarding accounts associated with the users. In some embodiments, an account may include or be a bank account, credit card account, debit card account, savings account, mortgage account, investment account, retirement plan, etc. A resource may be or include a database, Web site, Web page, log, file server, document, etc. associated with the account.

As one example, a method for facilitating security for access to a resource in accordance with the present invention may include providing a first code to an individual at an address of record associated with the user, wherein the user is associated with an account; providing a second code to the first individual via a first statement for the account; and requiring the first individual to provide the first code and the second code when the first individual attempts to access a resource associated with the account. The statement may be or include a billing statement. Different billing statements sent to the same customer may include different second codes.

Additional advantages and novel features of the invention shall be set forth in part in the description that follows, and in part will become apparent to those skilled in the art upon examination of the following or may be learned by the practice of the invention.

According to some embodiments of the present invention, a method for facilitating security for access to a resource may include providing a first code to an individual at an address of record associated with the user, wherein the user is associated with an account; providing a second code to the first individual via a first statement for the account; and requiring the first individual to provide the first code and the second code when the first individual attempts to access a resource associated with the account. In other embodiments, a method for distributing information to an individual associated with a financial account may include providing a communication to an address of record for an individual associated with a financial account, wherein the communication includes a first code and the first code is associated with the individual and the account; and providing a statement to the individual regarding the financial account, wherein the statement includes a second code and the second code is associated with the account and the statement. In further embodiments, a method for distributing information to individuals associated with respective financial accounts may include providing communications to addresses of record for a plurality of individuals, wherein each of the plurality of individuals is associated with a respective financial account, and wherein a communication sent to an individual includes a first code that is associated with the individual and the individual's respective financial account; determining a plurality of second codes; and providing statements to each of the plurality of individuals regarding their respective financial accounts, wherein each of the statements includes a unique one of the plurality of second codes.

According to some embodiments of the present invention, a system for facilitating security for access to a resource may include a memory; a communication port; and a processor connected to the memory and the communication port, the processor being operative to provide a first code to an individual at an address of record associated with the user, wherein the user is associated with an account; provide a second code to the first individual via a first statement for the account; and require the first individual to provide the first code and the second code when the first individual attempts to access a resource associated with the account. In further embodiments, a system for facilitating distribution of information may include a memory; a communication port; and a processor connected to the memory and the communication port, the processor being operative to provide a communication to an address of record for an individual associated with a financial account, wherein the communication includes a first code and the first code is associated with the individual and the account; and provide a statement to the individual regarding the financial account, wherein the statement includes a second code and the second code is associated with the account and the statement. In other embodiments, a system for facilitating distribution of information may include a memory; a communication port; and a processor connected to the memory and the communication port, the processor being operative to send communications to addresses of record for a plurality of individuals, wherein each of the plurality of individuals is associated with a respective financial account, and wherein a communication sent to an individual includes a first code that is associated with the individual and the individual's respective financial account; determine a plurality of second codes; and send statements to each of the plurality of individuals regarding their respective financial accounts, wherein each of the statements includes a unique one of the plurality of second codes.

According to some embodiments of the present invention, a computer program product in a computer readable medium for facilitating security for access to a resource may include first instructions for sending a first code to an individual at an address of record associated with the user, wherein the user is associated with an account; second instructions for sending a second code to the first individual via a first statement for the account; and third instructions for obtaining the first code and the second code when the first individual attempts to access a resource associated with the account. In further embodiments, a computer program product in a computer readable medium for distributing information to an individual associated with a financial account may include first instructions for sending a communication to an address of record for an individual associated with a financial account, wherein the communication includes a first code and the first code is associated with the individual and the account; and second instructions for sending a statement to the individual regarding the financial account, wherein the statement includes a second code and the second code is associated with the account and the statement. In other embodiments, a computer program product in a computer readable medium for distributing information may include first instructions for sending communications to addresses of record for a plurality of individuals, wherein each of the plurality of individuals is associated with a respective financial account, and wherein a communication sent to an individual includes a first code that is associated with the individual and the individual's respective financial account; second instructions for identifying a plurality of second codes; and third instructions for sending statements to each of the plurality of individuals regarding their respective financial accounts, wherein each of the statements includes a unique one of the plurality of second codes.

According to some embodiments of the present invention, an apparatus for facilitating security for access to a resource may include means for sending a first code to an individual at an address of record associated with the user, wherein the user is associated with an account; means for sending a second code to the first individual via a first statement for the account; and means for obtaining the first code and the second code when the first individual attempts to access a resource associated with the account. In further embodiments, an apparatus for distributing information to an individual associated with a financial account may include means for sending a communication to an address of record for an individual associated with a financial account, wherein the communication includes a first code and the first code is associated with the individual and the account; and means for sending a statement to the individual regarding the financial account, wherein the statement includes a second code and the second code is associated with the account and the statement. In other embodiments, an apparatus for distributing information may include means for sending communications to addresses of record for a plurality of individuals, wherein each of the plurality of individuals is associated with a respective financial account, and wherein a communication sent to an individual includes a first code that is associated with the individual and the individual's respective financial account; means for identifying a plurality of second codes; and means for sending statements to each of the plurality of individuals regarding their respective financial accounts, wherein each of the statements includes a unique one of the plurality of second codes.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a flowchart of a third embodiment of a method in accordance with the present invention;

FIG. 4 is a block diagram of system components for an embodiment of an apparatus usable with the methods of FIGS. 1-3;

FIG. 5 is a block diagram of components for an embodiment of a server of FIG. 4;

FIG. 6 is an illustration of a representative account information database of FIG. 5;

FIG. 7 is an illustration of a representative statement information database of FIG. 5; and

FIG. 8 is an illustration of a representative user information database of FIG. 5.

### DETAILED DESCRIPTION

Applicants have recognized that there is a need for systems, means and methods for distributing security information used to access a resource and for facilitating secure access to a resource. A resource may be used to provide information to users regarding accounts associated with the users. In some embodiments, an account and/or user may be considered to be “associated” with a resource if, among other things, the resource has or includes information (e.g., balances, payment history) regarding the account or user, the resource provides customer service, communication or marketing services, etc. regarding the account or user, the resource provides a way for a user to inquire about an account, etc. A resource may be able to provide information or support for many accounts or users.

In some embodiments, an account may include or be a bank account, credit card account, debit card account, savings account, mortgage account, investment account, retirement plan, etc. A resource may be or include a database, Web site, Web page, log, file server, document, etc. For example, a credit card issuer operate a Web site on which credit card holders or credit card administrators can access information regarding their accounts; view payment information, account statements and balances; request credit limit extensions; add or delete accounts; submit questions regarding their accounts; etc. Among others, one technical effect provided by the present invention is enhanced security for credit card issuers and other financial account administrators. These and other features will be discussed in further detail below, by describing a system, individual devices, and processes according to embodiments of the invention.

Process Description

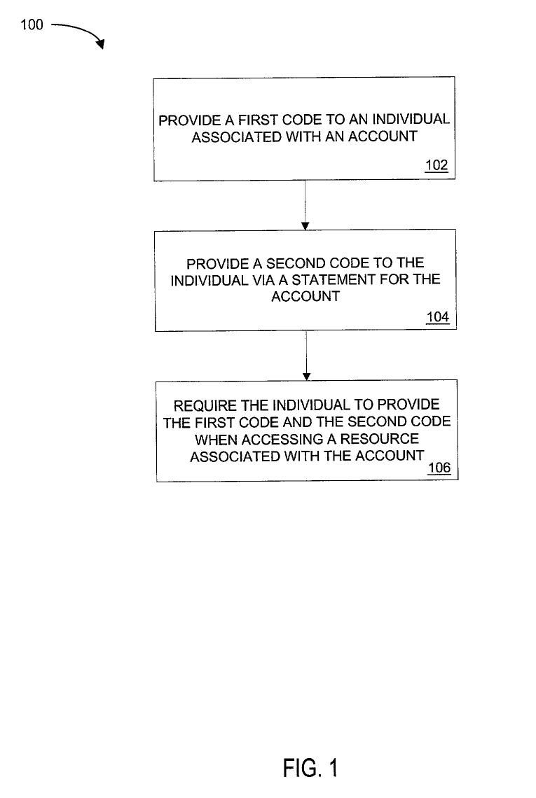

Reference is now made to FIG. 1, where a flow chart 100 is shown which represents the operation of a first embodiment of the present invention. The particular arrangement of elements in the flow chart 100 is not meant to imply a fixed order to the steps; embodiments of the present invention can be practiced in any order that is practicable. The method 100 is particularly well suited for use in establishing security for a resource (e.g., database, Web site, file server, document, log, etc.) that one or more users may need or try to access.

Processing begins at a step 102 during which a first code is provided directly or indirectly to an individual or user associated with an account. The first code may be or include any sort of numerical, alphabetic, alphanumeric, or other code, identifier or sequence and the method 100 is not limited by the type, length, language, structure and/or format of the first code.

For example, how the first code is provided to an individual during step 102 may vary depending on the type of account. For example, for credit card accounts, the first code for a particular individual may be printed on the credit card provided to the individual. More specifically, the first code may be or include a card verification value (CVV) or a card validation code (CVC) printed on the credit card. As another example, for an individual who already has a credit card, the first code may be mailed to the individual. The first code may be printed on a label or sticker that the individual can attach to the credit card.

Other ways also exist to provide the first code to an individual. For example, in some embodiments, the first code may be sent to the individual in a letter, email message, facsimile transmission, instant message communication, radio signal, FTP transmission, etc. As another example, in some embodiments of the step 102, an individual may be provided with data (e.g., computer address, URL, hyperlink) that directs the individual to a location where the individual can retrieve the first code. As a third example, in some embodiments of the step 102, the individual may be provided with an algorithm that enables the individual to generate the first code. More specifically, a Web site that the individual can access may tell the individual how to create the first code. The Web site may include an algorithm or mathematical function that the individual uses to create the first code. The algorithm may use other information unique to the individual (e.g., the individual's social security number, credit card number, account number) to generate the first code. As another example, in some embodiments of the step 102, an individual may be provided with data (e.g., computer address, URL, hyperlink) that directs the individual to a location where the individual can retrieve an algorithm that the individual can use to create the first code. As a fifth example, in some embodiments of the step 102, the individual may be allowed to select a first code or indicate or request a desired first code. The individual may then receive an approval or denial of the individual's selection or request. More specifically, the individual may access a Web site or other resource and provide an indication of the first code that the individual wants to use. The Web site may determine if the individual can use the indicated first code and indicate approval or denial to the individual.

In some embodiments, the first code may be or may be required to be unique. That is, no two individuals will be allowed to have, use and/or receive the same first code. In some embodiments, the first code may have a minimum and/or maximum allowable size, a designated character set (e.g., all English language characters), a specific format (e.g., three letters followed by three numbers), etc.

During a step 104, a statement is provided to the individual regarding the account, wherein the statement includes a second code. As with the first code, the second code may be any sort of numerical, alphabetic, alphanumeric, or other code or sequence and the method 100 is not limited by the type, length, and/or format of the second code. In some embodiments, the statement may be or include a billing statement for the account, a notification of a formation of the account, a notification a use of the account, etc. The communication may be in any format or form. For example, in some embodiments, the communication may be or include a letter, email message, facsimile transmission, radio signal, FTP transmission, instant message communication, etc.

In some embodiments, the step 104 may be or include allowing an individual to request a second code and providing an indication of an acceptance of the request in a statement; providing an algorithm to an individual in a statement that can be used by the individual to created a second code; providing data in a statement indicative of a location where the individual can retrieve the second code or an algorithm usable to create the second code; etc.

During a step 106, the individual is required to provide both the first code and the second code when accessing or attempting to access the resource. For example, the resource may provide customer service and other assistance or information to people regarding credit card accounts, balances, charges, limits, etc. An individual having a credit card may be able to access the resource to determine the current balance for the credit card, retrieve information regarding one or more previous uses of the credit card, make a payment towards the outstanding balance of the credit card, ask a question regarding a previous bill or payment, etc. In some embodiments, once the individual has accessed the resource using the first code and the second code, the individual may be able to use the resource for a designated period of time, to change either the first code and/or the second code, to establish a login/password for later access to the resource, etc. In addition, the resource may grant or provide the individual with a temporary or permanent access credential to use, update or access the resource.

In some embodiments, there may be many individuals with accounts. Each statement sent to one of the individuals may have a different second code so that no two individuals ever receive the same second code. For example, suppose a credit card issuer wants to enable secure access by individuals with credit cards to a Web site that provides customer service and other information to the individuals regarding their accounts. The issuer may want to limit or prevent access to the Web site by non-credit card holders. Thus, the issuer may provide the first codes to individuals when sending the original credit cards to the individuals. The first codes may or may not be unique. In addition, the issuer may send statements to the individuals on a regular or periodic basis regarding their respective accounts. For example, the issuer may send out billing statements once a month to the individuals regarding their respective credit card accounts. Each statement may include a statement security code (e.g., the second code) that is unique to the statement and is not provided in any manner other than on the statement. The individual who receives the statement presumably has previously received the first code and may access the Web site. If the statement is lost or stolen by another party, the party will not have the first code and, as a result, cannot access the Web site. Similarly, if the first code is stolen or learned by another party, the party will not be able to access the resource without the second code included in the statement.

In some embodiments, the second code may have a limited validity time. For example, a statement regarding a credit card and including a statement security number (e.g., the second code) may be sent to an individual. The individual may be able to use the statement security code along with the first code previously received by the individual for a limited period of time (e.g., day, week, month, year) before the second code is no longer valid and can no longer be used to access the Web site. In this manner, if the statement is stolen or otherwise not received by the individual, the second code is usable for only a limited period of time. If the individual does not access the Web site within the period of time, the individual may receive a new or different statement security number (e.g., a new second code) in the next statement sent to the individual regarding the individuals' account.

In some embodiments, once the individual has accessed a resource using the first code and the second code, the second code may be assigned to or otherwise associated with the individual for a designated or permanent period of time (e.g., quarter, year, indefinitely). In such cases, in some embodiments, the next statement sent to the individual may include the same second code as the previous statement. Alternatively, the next statement sent to the individual may not contain any second code, as the individual will be presumed to know the second already. Thus, security for the resource is enhanced by limiting distribution of second codes via statements, since a second code actually used by the individual to access the resource will be sent only once to the individual. If the individual fails to use the second code within its designated time period of validity, a new second code is sent to the user in an account statement. Once the user uses both a first code and a second code, the user is not sent either the first code or the second code again and is assumed to know or remember the first code and the second code.

As an example of the previous embodiment, assume that ten thousand account holders exist. Each account holder has a credit card that includes an additional first code printed on it in addition to the credit card number. During a first month, each of the ten thousand account holders is sent a billing statement, each billing statement having on it a different statement security number (i.e., a different second code). Each of the statement security numbers is valid for thirty days. If four thousand of the account holders use their respective first codes and statement security numbers to access a resource with the designated thirty day period, the four thousand statement security numbers associated with the four thousand account holders are linked permanently to the respective account holders. As a result, a statement security number sent to one of the four thousand account holders remains associated with the account holder. In addition, the statement security number is not used again with any statement sent in the future to any other account holder. At the next mailing of billing statements the following months, the six thousand account holders who did not access the resource may be sent statements with entirely new or different statement security numbers. In some cases, however, the later statements sent to the four thousand account holders who did access the resource may continue to have the same statement security number as the four thousand account holders received the previous month. Alternatively, the later statements sent to the four thousand account holders may not list or include any statement security number at all since each of the four thousand account holders will be assumed to be able to remember or locate their respective statement security number when needed.

In some embodiments, the first code, second code, and/or statement may be sent or provided to an address of record for the individual. Thus, in some embodiments, the method 100 may include determining an address of record for the individual.

In some embodiments, the first code may be sent to the individual via one delivery channel or method (e.g., letter sent via U.S. mail, instant message communication) while the statement is sent to the individual via a different delivery channel of method (e.g., email communication, facsimile transmission). Thus, in some embodiments, the method 100 may include determining a first communication channel via which to send the first code, sending the first code via a first communication channel, determining a second communication channel via which to send the statement, and/or sending the statement via a second communication channel.

In some embodiments, the method 100 may include determining one or more first codes, determining one or more second codes, associating one or more first codes with one or more accounts and/or individuals, associating one or more second codes with one or more accounts and/or statements, etc.

In some embodiments, information regarding one or more accounts may be stored in or accessed from an account information database. Similarly, in some embodiments, information regarding one or more statements may be stored in or accessed from a statement information database. Likewise, in some embodiments, information regarding one or more individuals may be stored in or accessed from a user information database.

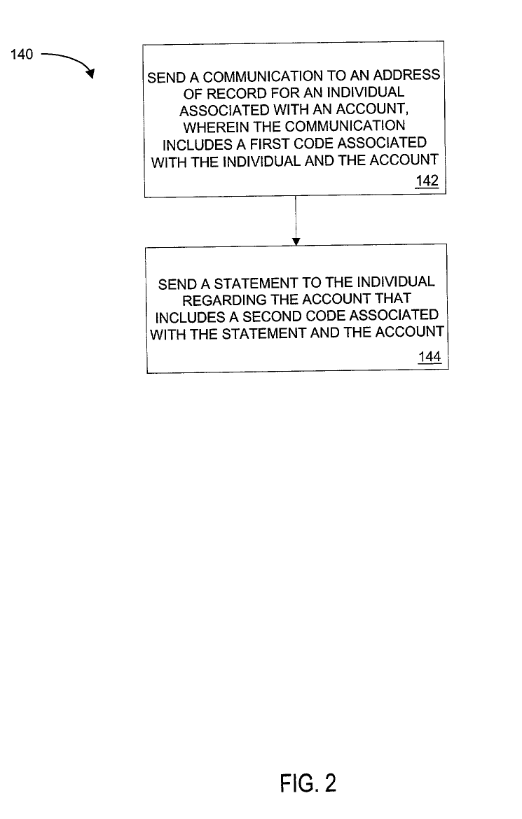

Reference is now made to FIG. 2, where a flow chart 140 is shown which represents the operation of a second embodiment of the present invention. The particular arrangement of elements in the flow chart 140 is not meant to imply a fixed order to the steps; embodiments of the present invention can be practiced in any order that is practicable. In some embodiments, the method 140 may include some or all of the variations discussed above in relation to the method 100.

Processing begins at a step 142 during which a communication (e.g., letter, flyer, email message, instant message communication, facsimile transmission, card) is sent to an address of record (e.g., postal address, email address, facsimile number) associated with an individual. The communication may include a first code that is associated with the individual and an account associated with the individual.

During a step 144, a communication is sent to the individual regarding the account, wherein the communication includes a second code that is associated with the account and the communication. Other communications sent to different individuals regarding different accounts may have different or even unique second codes. In addition, other communications regarding the same account sent the individual also may have different or unique second codes. Thus, each second code may be unique to a specific communication regarding a specific account. The individual may need to use the first code and the second code to access a resource associated with the account. In some embodiments, a second code provided on a statement may have a time period of validity associated with it.

In some embodiments, the method 140 may include one or more of the following: associating a second code with an individual for a period of time (which may be temporary, permanent, or indefinite) if the individual completes a designated activity (e.g., accesses a resource using the second code, registers an account); providing a new statement to an individual regarding an account, wherein the new statement includes a new second code if the individual does not complete a designated activity within a designated period of time following an earlier receipt of a different statement or a different second code; providing a new statement to an individual regarding an account, wherein the new statement does not include a new second code if the individual completes a designated activity within a designated period of time (e.g., a time period of validity associated with a different second code previously sent to the individual in a different statement); requiring an individual to provide a first code and a second code associated with the individual when the individual attempts to access a resource within a time period of validity associated with the second code; denying access by an individual to a resource if the individual attempts to access a resource using a first code and a second code outside a time period of validity associated with the second code; requiring am individual to provide a first code and a second code when the individual attempts to access a resource associated with an account; etc.

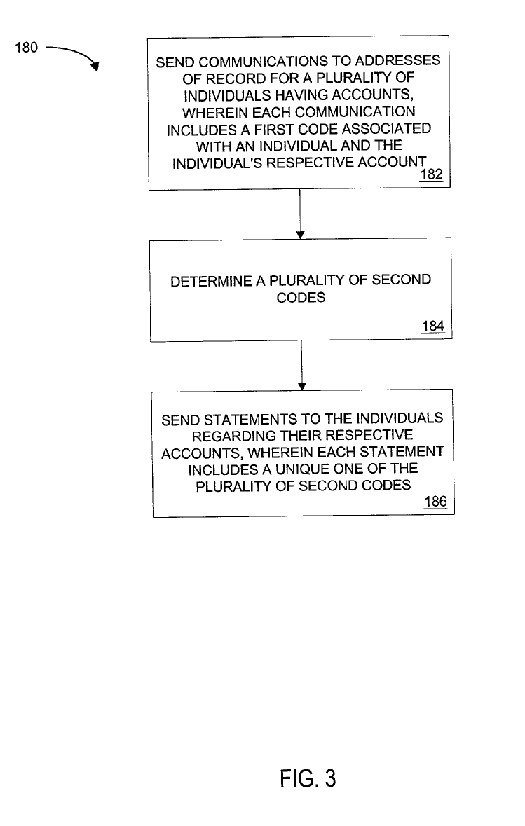

Reference is now made to FIG. 3, where a flow chart 180 is shown which represents the operation of a third embodiment of the present invention. The particular arrangement of elements in the flow chart 180 is not meant to imply a fixed order to the steps; embodiments of the present invention can be practiced in any order that is practicable. In some embodiments, the method 180 may include some or all of the variations discussed above in relation to the methods 100 and/or 140.

Processing begins at a step 182 during which communications (e.g., letter, flyer, email message, instant message communication, facsimile transmission, card) are sent to addresses of record (e.g., postal address, email address, facsimile number) associated with individuals having accounts. Each communication may include a first code that is associated with one of the individuals and an account associated with that individual. The step 182 is similar to the step 142 previously discussed above.

During a step, 184, a plurality of second codes are determined or otherwise identified. The number of codes may vary. In some embodiments, the number of codes may depend on or be related to the number individuals (e.g., the number of codes may need to be at least as large as the number of individuals). In addition, the number of codes may depend on how many codes may be needed to send different codes to each individual for each communication over a period of time. For example, if a different communication needing a different code is sent to each of ten thousand individuals each month for five years, then six hundred thousand different codes may be needed.

During a step 186, communications are sent to the individuals regarding their respective accounts, wherein each of the communications includes a second code that is associated with an individual's account and the communication. Other communications regarding different accounts may have different second codes. In addition, other communications regarding the same account also may have different second codes. Thus, each second code may be unique to a specific communication regarding a specific account. An individual may need to use the individual's first code and second code to access a resource associated with the account. The step 186 is similar to the step 144 previously discussed above.

System

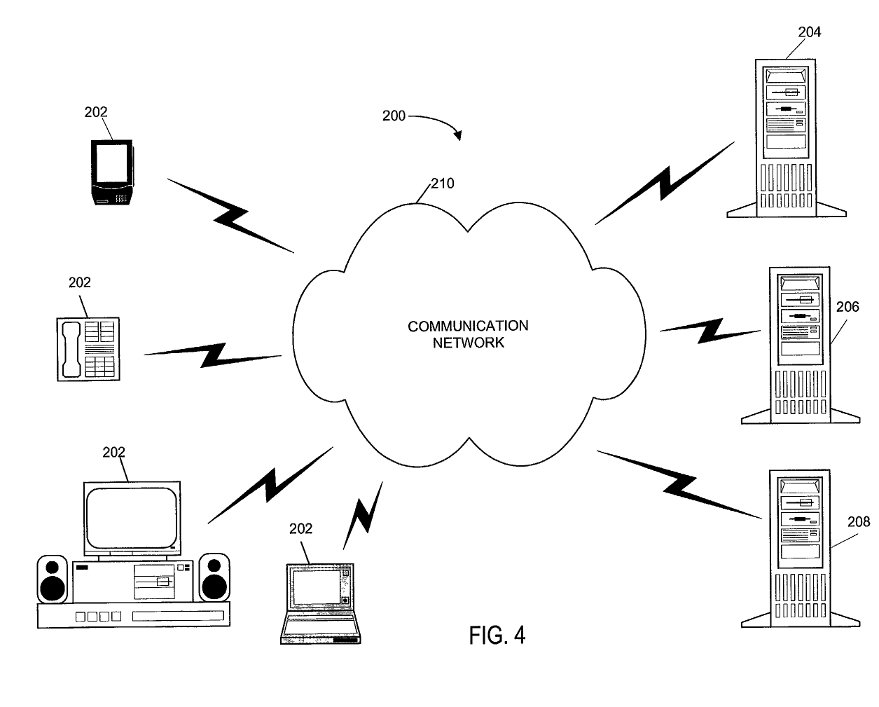

Now referring to FIG. 4 an apparatus or system 200 usable with the methods disclosed herein is illustrated. The apparatus 200 includes one or more user or client devices 202 that may communicate directly or indirectly with one or more servers, controllers or other devices 204, 206, 208 via a computer, data, or other communications network 210.

A server 204 may implement or host a Web site. A server 204 can comprise a single device or computer, a networked set or group of devices or computers, a workstation, etc. In some embodiments, a server 204 also may function as a database server and/or as a user device. The use, configuration and operation of servers will be discussed in more detail below.

The user or client devices 202 preferably allow entities to interact with the server 204 and the remainder of the apparatus 200. The user devices 202 also may enable a user to access Web sites, software, databases, or other resources hosted or operated by the servers 204, 206, 208. If desired, the user devices 202 also may be connected to or otherwise in communication with other devices. Possible user devices include a personal computer, portable computer, mobile or fixed user station, workstation, network terminal or server, cellular telephone, kiosk, dumb terminal, personal digital assistant, etc. In some embodiments, information regarding one or more users and/or one or more user devices may be stored in, or accessed from, a user information database and/or a user device information database.

Many different types of implementations or hardware configurations can be used in the system 200 and with the methods disclosed herein and the methods disclosed herein are not limited to any specific hardware configuration for the system 200 or any of its components.

The communications network 210 might be or include the Internet, the World Wide Web, or some other public or private computer, cable, telephone, client/server, peer-to-peer, or communications network or intranet, as will be described in further detail below. The communications network 210 illustrated in FIG. 4 is meant only to be generally representative of cable, computer, telephone, peer-to-peer or other communication networks for purposes of elaboration and explanation of the present invention and other devices, networks, etc. may be connected to the communications network 210 without departing from the scope of the present invention. The communications network 210 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device 202 may be connected directly to the server 204 without departing from the scope of the present invention. Moreover, as used herein, communications include those enabled by wired or wireless technology.

Although three user devices 202 and three servers 204, 206, 208 are shown in FIG. 4, any number of such devices may be included in the system 200. The devices shown in FIG. 4 need not be in constant communication. For example, a user device 202 may communicate with the server 204 only when such communication is appropriate or necessary.

Server

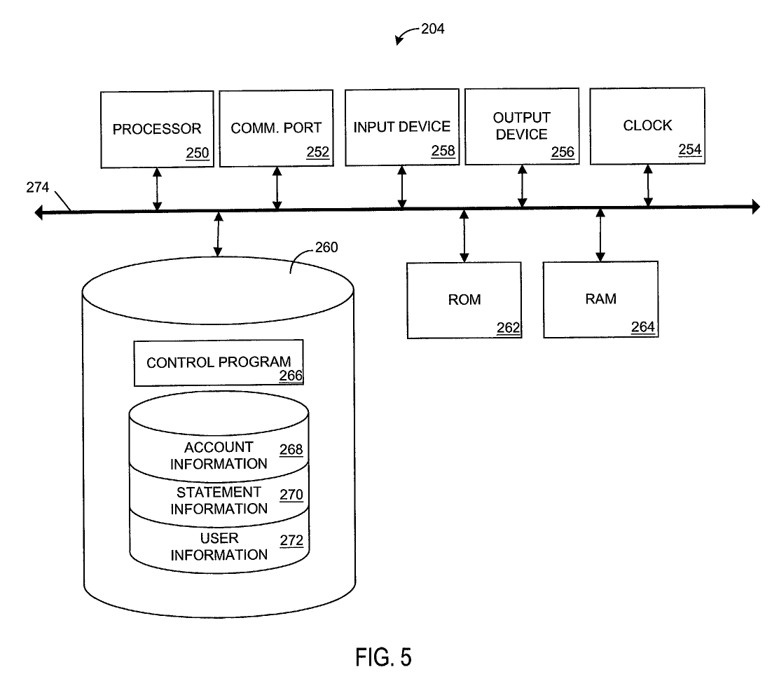

Now referring to FIG. 5, a representative block diagram of a server or controller 204 is illustrated. The server 204 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The server 204 also may include an internal clock element 254 to maintain an accurate time and date for the server 204, create time stamps for communications received or sent by the server 204, etc.

If desired, the server 204 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 204 may include a memory or data storage device 260 to store information, software, databases, communications, device drivers, account information, statement information, security codes, security algorithms, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 204 also may include separate ROM 262 and RAM 264.

The processor 250 and the data storage device 260 in the server 204 each may be, for example: (i) located entirely within a single computer or other computing device; or (ii) connected to each other by a remote communication medium, such as a serial port cable, telephone line or radio frequency transceiver. In some embodiments, the server 204 may comprise one or more computers that are connected to a remote server computer for maintaining databases.

A conventional personal computer or workstation with sufficient memory and processing capability may be used as the server 204. In some embodiments, the server 204 operates as or includes a Web server for an Internet environment. The server 204 preferably is capable of high volume transaction processing, performing a significant number of mathematical calculations in processing communications and database searches. A Pentium™ microprocessor such as the Pentium IV™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the server 204. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The server 204 also may include or store information regarding users, user devices, content, accounts, statements, security codes, security algorithms, communications, etc. For example, information regarding one or more accounts may be stored in an account information database 268 for use by the server 204 or another device or entity. Information regarding one or more statements may be stored in a statement information database 270 for use by the server 204 or another device or entity and information regarding one or more users may be stored in a user information database 272 for use by the server 204 or another device or entity. In some embodiments, some or all of one or more of the databases may be stored or mirrored remotely from the server 204.

According to an embodiment of the present invention, the instructions of the control program may be read into a main memory from another computer-readable medium, such as from the ROM 262 to the RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 274.

While specific implementations and hardware configurations for servers 204 have been illustrated, it should be noted that other implementations and hardware configurations are possible and that no specific implementation or hardware configuration is needed. Thus, not all of the components illustrated in FIG. 5 may be needed for a server implementing the methods disclosed herein. Therefore, many different types of implementations or hardware configurations can be used in the system 200 and the methods disclosed herein are not limited to any specific hardware configuration.

User Device

As mentioned above, user device 202 may be or include any of a number of different types of devices, including, but not limited to a personal computer, portable computer, mobile or fixed user station, workstation, network terminal or server, telephone, beeper, kiosk, dumb terminal, personal digital assistant, facsimile machine, two-way pager, radio, cable set-top box, etc. In some embodiments, a user device 202 may have the same structure or configuration as the server 204 illustrated in FIG. 5 and include some or all of the components of the server 204.

Databases

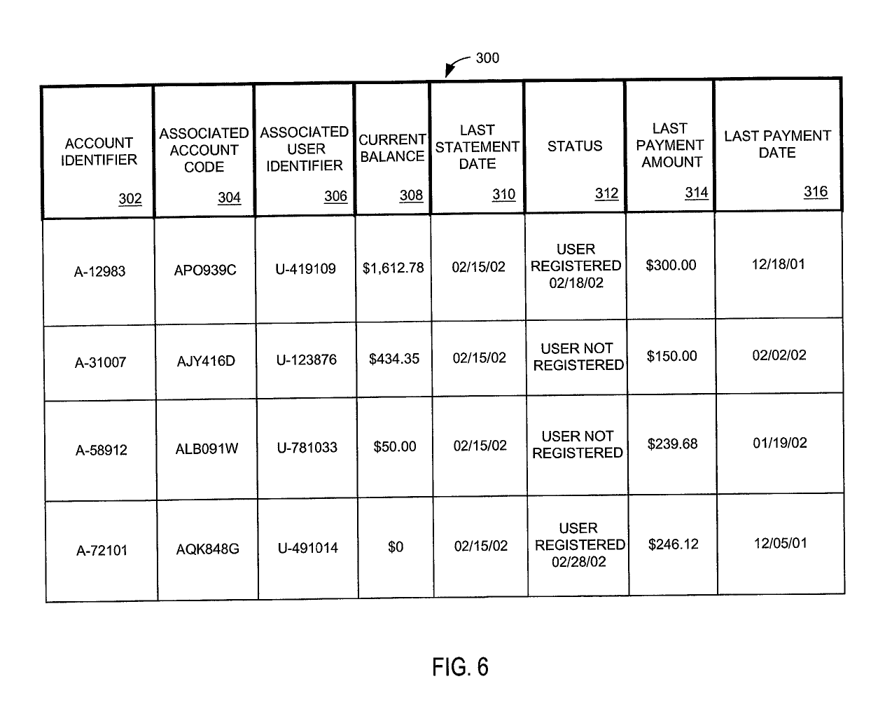

As previously discussed above, in some embodiments a server, user device, or other device may include or access an account information database for storing or keeping information regarding one or more accounts. One representative account information database 300 is illustrated in FIG. 6.

The account information database 300 may include an account identifier field 302 that may include codes or other identifiers for one or more accounts, an associated account code field 304 that may include codes or other identifiers associated with the accounts identified in the field 302, an associated user identifier field 306 that may include codes or other identifiers for users associated with the accounts identified in the field 302, a current balance field 308 that may include information regarding the current balances for the accounts identified in the field 302, a last statement date field 310 that may include information regarding the last time billing or other statements were sent to the users identified in the field 306 regarding the accounts identified in the field 302, a status field 312 that may include information regarding the status of the users identified in the field 306 and/or the accounts identified in the field 302, a last payment amount field 314 that may include information regarding one or more previous payments made towards the balances of the accounts identified in the field 302, and a last payment date field 316 that may include information regarding the payment dates associated with the payment amounts described in the field 314.

Other or different fields also may be used in the account information database 300. For example, in some embodiments an account information database may include information regarding how and where a user made a payment toward the balance of an account, information regarding account or credit limits associated with an account, information regarding where and when a user last used an account (e.g., where did the user last use a credit card associated with the account), information regarding interest rates associated with accounts, information regarding delinquent or late payments made by users, etc.

As illustrated by the account information database 300 of FIG. 6, the account identified as “A-12983 in the field 302 is associated with the user identified as “U-419109” and has a current balance of $1612.78. The account “A-12983” is associated with the account code “APOo939C”. A statement regarding the account “A-12983” was sent to the user “U-419109” on Feb. 15, 2002. The user “U-419109” registered using the associated account code “APO939C” on Feb. 18, 2002. In addition, the user “U-419109” last made a payment towards the balance of the account on Dec. 18, 2001, in the amount of three hundred dollars.

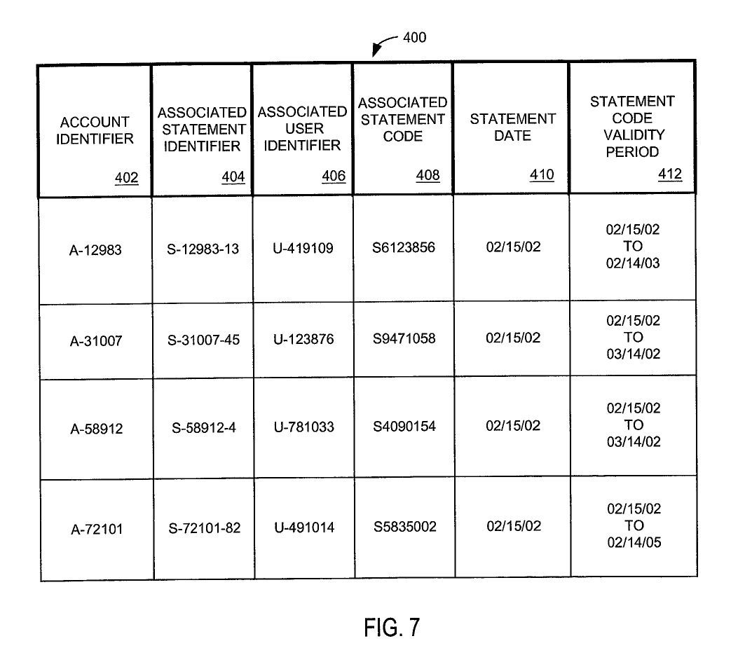

As previously discussed above, in some embodiments a server, user device, or other device may include or access a statement information database for storing or keeping information regarding one or more statements. One representative statement information database 400 is illustrated in FIG. 7.

The statement information database 400 may include an account identifier field 402 that may include codes or other identifiers for one or more accounts, an associated statement identifier field 404 that may include codes or other identifiers for statements associated with the accounts identified in the field 402, an associated user identifier field 406 that may include codes or other identifiers for users associated with the accounts identified in the field 402 and the statements identified in the field 404, an associated statement security code field 410 that may include codes associated with the statements identified in the field 404, and a statement code validity period field 412 that may include information regarding time periods that the statement security codes identified in the field 410 are valid. Other or different fields also may be used in the statement information database 400. For example, in some embodiments a statement information database may include information regarding how and where a statement was sent to a user, information regarding one or more previous statements sent to the users regarding accounts, information regarding previous statement security codes sent to users in previous statements, information regarding URLs, links or other data, information or content included in one or more statements, etc. For example, the account identified as “A-12983” may have multiple statements associated with it.

As illustrated by the statement information database 400 of FIG. 7, the statement identified as “S-12983-13” in the field 404 is associated with the account identified as “A-12983” and the user identified as “U-419109”. The “−13” portion of the statement identifier “S-12983-13” may indicate that thirteen previous statements have been sent to the user “U-419109” regarding the account “A-12983”. The statement “S129983-13” may have included the statement security code “S6123856” and was sent to the user “U-419109” on Feb. 15, 2002. The statement security code “S6123856” is valid only during the time period including and between Feb. 15, 2002, and Feb. 14, 2003. As indicated by the account information database 300 of FIG. 6, the user identified as “U-419109” has registered. Thus, the user may not be given a different or new statement security code on his next statement. In addition, once the user “U-419109” has registered, later statements sent to the user may not include a statement security code.

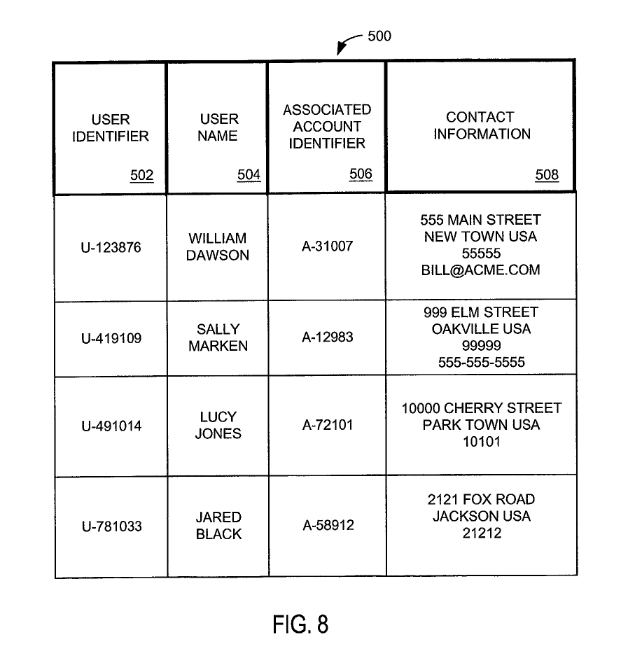

As previously discussed above, in some embodiments a server, user device, or other device may include or access a user information database for storing or keeping information regarding one or more users. One representative user information database 500 is illustrated in FIG. 8.

The user information database 500 may include a user identifier field 502 that may include codes or other identifiers for one or more users, a user name field 504 that may include names or other information regarding the users identified in the field 502, an associated account identifier field 506 that may includes codes or other identifiers for accounts associated with the users identified in the field 502, and a contact information field 508 that may include contact information (e.g., postal addresses, telephone numbers, facsimile numbers, email addresses, etc.) for the users identified in the field 502.

Other or different fields also may be used in the user information database 500. For example, in some embodiments a user information database may include demographic information (e.g., age, occupation, sex, annual income, nationality, preferences, hobbies, marital status, family status, etc.) regarding one or more of the users, information credit history, credit performance, account performance, etc. for one or more of the users, information regarding shopping and purchasing history for one or more users, etc.

As illustrated by the user information database 500 of FIG. 8, the user identified as “U-123876” in the field 502 is named “WILLIAM DAWSON” and is associated with the account identified as “A-31007”. The user “U-123876” can be contacted at the postal address or email address (i.e., BILL@ACME.COM) given in the field 508.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for facilitating security for access to a resource, comprising:
providing a first code to an individual at an address of record associated with said user, wherein said user is associated with an account;
providing a second code to said first individual via a first statement for said account; and
requiring said first individual to provide said first code and said second code when said first individual attempts to access a resource associated with said account.

2. The method of claim 1, wherein said providing a first code to an individual at an address of record associated with said user, wherein said user is associated with an account includes at least one of the following:
allowing said individual to request a first code and providing an indication of an acceptance of said request;
providing an algorithm to said individual that can be used by said individual to create said first code;
providing data to said individual indicative of a location where said individual can retrieve said first code;
providing data to said individual indicative of a location where said individual can retrieve a algorithm that can be used to create said first code; and
providing a communication to said individual that includes said first code.

3. The method of claim 1, wherein said providing a first code to an individual at an address of record associated with said user, wherein said user is associated with an account includes at least one of the following:
providing said first code in an email message;
providing said first code via a communication sent to a postal address;
providing said first code on a label attachable to a credit card;
providing said first code on a credit card; and
providing said first code via an instant message communication.

4. The method of claim 1, wherein said providing a second code to said first individual via a first statement for said account includes at least one of the following:
allowing said individual to request a second code and providing an indication of an acceptance of said request in said first statement;
providing an algorithm to said individual in said first statement that can be used by said individual to create said second code;
providing data in said statement indicative of a location where said individual can retrieve said second code; and
providing data in said statement indicative of a location where said individual can retrieve a algorithm that can be used to create said second code.

5. The method of claim 1, wherein said requiring said first individual to provide said first code and said second code when said first individual attempts to access a resource associated with said account includes prompting said individual to provide said first code and said second code when said individual attempts to access said resource.

6. The method of claim 1, wherein said account has an associated account number.

7. The method of claim 6, further comprising:
requiring said first individual to provide said account number when said first individual attempts to access said resource.

8. The method of claim 6, wherein said account number and said first code are provided on a credit card associated with said account and provided to said first individual.

9. The method of claim 1, wherein said providing a first code to an individual at an address of record associated with said user includes providing said first code via a first delivery channel and said providing a second code to said first individual via a first statement for said account includes providing said first statement via a second delivery channel.

10. The method of claim 1, wherein said second code has an associated time period of validity.

11. The method of claim 10, further comprising:
denying access by said first individual to said resource if said first individual attempts to access said resource using said first code and said second code outside said time period of validity.

12. The method of claim 10, further comprising:
providing a third code to said first individual via a second statement for said account; and
requiring said first individual to provide said first code and said third code when said first individual attempts to access a resource associated with said account after said time period of validity.

13. The method of claim 1, further comprising:
associating said second code with said first individual for a designated period of time if said first individual accesses said resource using said second code.

14. The method of claim 13, wherein said second code is not used for any other statements during said period of time.

15. The method of claim 1, providing said second code to a second individual via a statement for an account associated with said second individual if said first individual does not access said resource using said second code during a designated period of time.

16. The method of claim 1, wherein said first statement is a billing statement.

17. The method of claim 1, further comprising:
determining an address of record for said individual.

18. A method for distributing security information to an individual associated with a financial account, comprising:
providing a communication to an address of record for an individual associated with a financial account, wherein said communication includes a first code and said first code is associated with said individual and said account; and
providing a statement to said individual regarding said financial account, wherein said statement includes a second code and said second code is associated with said account and said statement.

19. The method of claim 18, wherein said statement is a billing statement.

20. The method of claim 18, wherein said second code is unique to said statement.

21. The method of claim 18, further comprising:
associating said second code with said individual for a period of time if said individual completes a designated activity.

22. The method of claim 18, further comprising:
providing a new statement to said individual regarding said financial account, wherein said new statement includes a new second code if said individual does not complete a designated activity within a designated period of time.

23. The method of claim 18, further comprising:
providing a new statement to said individual regarding said financial account, wherein said new statement does not include a second code if said individual completes a designated activity within a designated period of time.

24. The method of claim 18, wherein said second code has an associated time period of validity.

25. The method of claim 24, further comprising:
requiring said individual to provide said first code and said second code when said individual attempts to access a resource within said time period of validity.

26. The method of claim 24, further comprising:
denying access by said individual to a resource if said individual attempts to access a resource using said first code and said second code outside said time period of validity.

27. The method of claim 18, further comprising:
requiring said individual to provide said first code and said second code when said first individual attempts to access a resource associated with said account.

28. A method for distributing information to individual associated with respective financial accounts, comprising:
providing communications to addresses of record for a plurality of individuals, wherein each of said plurality of individuals is associated with a respective financial account, and wherein a communication sent to an individual includes a first code that is associated with said individual and said individual's respective financial account;
determining a plurality of second codes; and
providing statements to each of said plurality of individuals regarding their respective financial accounts, wherein each of said statements includes a unique one of said plurality of second codes.

29. The method of claim 28, further comprising:
associating at least one of said plurality of second codes to a respective at least one of said plurality of individuals for a designated period of time.

30. The method of claim 28, wherein each of said plurality of second codes included in said statements has an initial time period of validity associated with it.

31. A system for facilitating security for access to a resource, comprising:
a memory;
a communication port; and
a processor connected to said memory and said communication port, said processor being operative to:
provide a first code to an individual at an address of record associated with said user, wherein said user is associated with an account;
provide a second code to said first individual via a first statement for said account; and
require said first individual to provide said first code and said second code when said first individual attempts to access a resource associated with said account.

32. A system for facilitating distribution of information, comprising:
a memory;
a communication port; and
a processor connected to said memory and said communication port, said processor being operative to:
send communications to addresses of record for a plurality of individuals, wherein each of said plurality of individuals is associated with a respective financial account, and wherein a communication sent to an individual includes a first code that is associated with said individual and said individual's respective financial account;
determine a plurality of second codes; and
send statements to each of said plurality of individuals regarding their respective financial accounts, wherein each of said statements includes a unique one of said plurality of second codes.

33. A computer program product in a computer readable medium for facilitating security for access to a resource, comprising:
first instructions for sending a first code to an individual at an address of record associated with said user, wherein said user is associated with an account;
second instructions for sending a second code to said first individual via a first statement for said account; and
third instructions for obtaining said first code and said second code when said first individual attempts to access a resource associated with said account.

34. A computer program product in a computer readable medium for distributing information, comprising:
first instructions for sending communications to addresses of record for a plurality of individuals, wherein each of said plurality of individuals is associated with a respective financial account, and wherein a communication sent to an individual includes a first code that is associated with said individual and said individual's respective financial account;
second instructions for identifying a plurality of second codes; and
third instructions for sending statements to each of said plurality of individuals regarding their respective financial accounts, wherein each of said statements includes a unique one of said plurality of second codes.
